(19) United States
(12) Patent Application Publication
(10) Pub. No.: US 2015/0019792 A1
(43) Pub. Date: Jan. 15, 2015

(54) SYSTEM AND METHOD FOR IMPLEMENTING TRANSACTIONS USING STORAGE DEVICE SUPPORT FOR ATOMIC UPDATES AND FLEXIBLE INTERFACE FOR MANAGING DATA LOGGING

(71) Applicant: The Regents of the University of California, Oakland, CA (US)

(72) Inventors: Steven Swanson, San Diego, CA (US); Joel Coburn, La Jolla, CA (US); Trevor Bunker, San Juan Capistrano, CA (US)

(21) Appl. No.: 14/368,490

(22) PCT Filed: Jan. 23, 2013
(86) PCT No.: PCT/US2013/022809

§ 371 Date: Jun. 24, 2014

Related U.S. Application Data
(60) Provisional application No. 61/589,778, filed on Jan. 23, 2012.

(51) Int. Cl. G06F 9/54; G06F 12/02

(52) U.S. Cl. CPC G06F 9/54; G06F 12/0223; G06F 2212/202
USPC 711/102; 719/313

(57) ABSTRACT

Systems and methods provide an efficient method for executing transactions on a storage device (e.g., a disk or solid-state disk) by using special support in the storage device for making a set of updates atomic and durable. The storage device guarantees that these updates complete as a single indivisible operation and that if they succeed, they will survive permanently despite power loss, system failure, etc. The storage device performs transaction (e.g., read/write) operations directly at storage device controllers. As a result, transactions execute with lower latency and consume less communication bandwidth between the host and the storage device. Additionally, a unique interface is provided which allows the application to manage the logs used by the hardware.

### TECHNICAL FIELD

The present invention relates to the control of read/write operations in a class of computer storage devices referred to as Non-Volatile Memory (NVM), and in particular, to an NVM storage architecture capable of targeting emerging, fast NVMs and providing a simple, flexible, and general-purpose interface for atomic write operations.

### BACKGROUND

Traditionally, systems that provide powerful transaction mechanisms often rely on write-ahead logging (WAL) implementations that were designed with slow, disk-based storage systems in mind. An emerging class of fast, byte-addressable, non-volatile memory (NVM) technologies (e.g., phase change memories, spin-torque MRAMs, and the memristor), however, present performance characteristics very different from both disks and flash-based Solid State Drives (SSDs). Challenges arise when attempting to design a WAL scheme optimized for these fast NVM-based storage systems.

Generally, conventional/existing storage systems that natively support atomic writes do not expose the logs to the application to support higher-level transactional features. Also, conventional/existing storage systems typically do not distribute the logging, commit, and write back operations to the individual controllers within the storage device.

### SUMMARY

Various embodiments provide an efficient method for executing transactions on a storage device (e.g., a disk or solid-state disk) by using special support in the storage device for making a set of updates atomic and durable. The storage device can guarantee that these updates complete as a single indivisible operation and that if they succeed, they will survive permanently despite power loss, system failure, etc. Normally, transactions are implemented entirely in software using techniques such as write-ahead logging. This requires multiple IO requests to the storage device to write data to a log, write a commit record, and write back the data to its permanent addresses. Instead, the storage device usually performs these operations directly at storage device controllers. As a result, transactions tend to execute with lower latency and consume less communication bandwidth between the host and the storage device.

In addition to performance improvements, and in accordance with various embodiments, a unique interface is provided which allows the application to manage the logs used by the hardware. The logs can be stored as regular files in the file system, so the application can extend or truncate the log files to match the working set of its transactions. The interface also can allow the application to specify the log address of an update. Consequently, a transaction can see its own updates before commit by reading back the data from the correct addresses in the log. These two features, namely scalability and transparency, help higher-level software provide robust and flexible transactions. Various embodiments of the present invention can be used in existing write-ahead logging schemes for databases, replacing software-only implementations and significantly reducing the complexity of storage management.

Another embodiment provides just for a “multi-part atomic copy” in which the program specifies a set of pairs of source and destination locations that define a set of copy operations. This embodiment can provide these to the SSD (perhaps singly or in a group), and the SSD can execute all of the copies atomically by copying (logically or physically) the contents from the source locations to the destination locations. To provide atomicity, the SSD can block other operations affecting the same data. Further, to ensure atomicity in the presence of system failure, the SSD can record the sequences of copies to be made so that they can be replayed on startup in the case of a system failure.

In particular, a storage array in accordance with various embodiments can target emerging fast non-volatile memories and provides hardware support for multi-part atomic write operations. The architecture can provide atomicity, durability, and high performance by leveraging the enormous internal bandwidth and high degree of parallelism that NVMs can provide. A simplified interface can be provided that lets the application manage log space, making atomic writes scalable and transparent. According to various embodiments, multi-part atomic writes can be used to implement full atomicity, consistency, isolation, durability (ACID) transactions. Embodiments, redesign Algorithms for Recovery and Isolation Exploiting Semantics (ARIES) and shadow paging to optimize them in light of these new memory technologies and the hardware support provided by the embodiments. The overhead of multi-part atomic writes with embodiments described herein can be minimal compared to normal writes, and hardware of described embodiments can provide large speedups for transactional updates to hash tables, b-trees, and large graphs. Finally, embodiments redesigning ARIES-style logging and shadow paging can leverage hardware transaction support for fast NVMs improve their performance by up to 2.7 times or more while reducing software complexity.

### BRIEF DESCRIPTION OF THE DRAWINGS

For a more complete understanding of example embodiments of the present invention, reference is now made to the following descriptions taken in connection with the accompanying drawings in which:

FIG. 1 depicts an exemplary SSD controller architecture in accordance with various embodiments;

FIG. 2 illustrates an exemplary log layout at a single logger in accordance with various embodiments;

FIG. 3 illustrates an exemplary logger module configured in accordance with various embodiments;

FIG. 4 illustrates an exemplary logger log layout in accordance with various embodiments;

FIG. 5 illustrates an exemplary latency breakdown for 512 B atomic writes in accordance with various embodiments;

FIG. 6 is a graph illustrating an exemplary transaction throughput achieved in accordance with various embodiments;

FIG. 7 is a graph illustrating exemplary internal bandwidth of a storage array in accordance with various embodiments;

FIG. 8 illustrates a comparison of MARS and ARIES according with various embodiments;

FIGS. 9A, 9B, and 9C are graphs comparing workload performance/throughput of a B+tree, hash table, and Six Degrees workloads in accordance with various embodiments; and

FIG. 10 is a graph illustrating exemplary MemcacheDB performance.

### DETAILED DESCRIPTION

Emerging fast non-volatile memory (NVM) technologies, such as phase change memory, spin-torque transfer memory, and the memristor promise to be orders of magnitude faster than existing storage technologies (i.e., disks and flash). Such a dramatic improvement can shift the balance between storage, system bus, main memory, and CPU performance and could facilitate storage architectures that maximize application performance by exploiting the memories' speed. While recent work focuses on optimizing read and write performance for storage arrays based on these memories, systems can also provide strong guarantees about data integrity in the face of failures.

File systems, databases, persistent object stores, and other applications that rely on persistent data structures should preferably provide strong consistency guarantees. Typically, these applications use some form of transaction to move the data from one consistent state to another. Some systems implement transactions using software techniques such as write-ahead logging (WAL) or shadow paging. These techniques typically incorporate complex, disk-based optimizations designed to minimize the cost of synchronous writes and leverage the sequential bandwidth of the disk.

NVM technologies can provide very different performance characteristics compared to disk, and exploiting them requires new approaches to implementing application-level transactional guarantees. NVM storage arrays provide parallelism within individual chips, between chips attached to a memory controller, and across memory controllers. In addition, the aggregate bandwidth across the memory controllers in an NVM storage array can outstrip the interconnect (e.g., PCIe) that connects it to the host system.

Embodiments described herein can comprise a WAL scheme, called Modified ARIES Redesigned for SSDs (MARS), optimized for NVM-based storage. The design of MARS reflects an examination of ARIES, a popular WAL-based recovery algorithm for database, in the context of these new memories. Embodiments described herein can separate the features that ARIES provides from the disk-based design decisions it makes. MARS according to embodiments of the disclosure can use a novel multi-part atomic write primitive, called editable redo logging (ERL) atomic writes, to implement ACID transactions on top of a novel NVM-based SSD architecture. These ERL atomic writes according to embodiments of the disclosure can make the ARIES-style transaction simpler and faster. They can also be a useful building block for other applications that must provide strong consistency guarantees.

ERL atomic write interfaces according to embodiments of the disclosure can support atomic writes to multiple portions of the storage array without alignment or size restrictions, and the hardware shoulders the burden for logging and copying data to enforce atomicity. This interface safely exposes the logs to the application and allows it to manage the log space directly, providing the flexibility that complex WAL schemes like MARS require. In contrast, recent work on atomic write support for flash-based SSDs typically hides the logging in the flash translation layer (FTL), resulting in higher bandwidth consumption in ARIES-style logging schemes.

Embodiments described herein can implement ERL atomic writes in a PCIe storage array. Micro-bench marks show that they can reduce latency by 2.9× or more compared to using normal synchronous writes to implement a traditional WAL protocol, and the ERL atomic writes increase effective bandwidth by between 2.0 and 3.8× or more by eliminating logging overheads. Compared to non-atomic writes, ERL atomic writes can reduce effective bandwidth just 18% and increase latency by just 30%.

Embodiment according to the disclosure can use ERL atomic writes to implement MARS, simple on-disk persistent data structures, and Memcache DB, a persistent version of memcached. MARS can improve performance by 3.7× or more relative to a base line version of ARIES. ERL atomic writes can speed up ACID key-value stores based on a hash table and a B+tree by 1.5× and 1.4× or more, respectively, relative to a software-based version, and ERL atomic writes can improve performance for a simple online scale-free graph query benchmark by 1.3× or more. Furthermore, performance for the ERL atomic write-based versions can be configured to be only 15% slower than non-transactional versions. For Memcache DB, replacing Berkeley DB with a ERL atomic write-based key-value store can improve performance by up to 3.8× or more.

This disclosure describes sample memory technologies and storage systems that can work with embodiments of the disclosure. ARIES in the context of fast NVM-based storage is discussed and ERL atomic writes and MARS are described. Embodiment described herein place this work in the context of prior work on support for transactional storage. Embodiments are described for implementing ERL atomic writes in hardware and this disclosure evaluates ERL atomic writes and their impact on the performance of MARS and other persistent data structures.

Fast NVMs may catalyze changes in the organization of storage arrays and how applications and the operating system (OS) access and manage storage. This disclosure describes the memories and architecture of an exemplary storage system and describes one possible implementation in detail.

Fast non-volatile memories such as phase change memories (PCM), spin-torque transfer memories, and/or memristor-based memories can differ fundamentally from conventional disks and from the flash-based SSDs that are beginning to replace them. Some of NVMs' most important features are their performance (relative to disk and flash) and their simpler interface (relative to flash). Predictions suggest that NVMs may have bandwidth and latency characteristics similar to dynamic random-access memory (DRAM). This can mean NVMs may be between 500 and 1500× or more faster than flash and 50,000× or more faster than disks.

One exemplary baseline storage array can be the so-called Moneta SSD. It can spread 64 GB of storage across eight memory controllers connected via a high-bandwidth ring. Each memory controller may provide 4GB/s of bandwidth for a total internal bandwidth of 32 GB/s. An 8-lane PCIe 1.1 interface can provide a 2 GB/s full-duplex connection (4 GB/s total) to the host system. One exemplary embodiment of the disclosure can run at 250 MHz on a Berkeley Emulation Engine, version 3 (BEE3) field-programmable gate array (FPGA) system.

The Moneta storage array can be used to emulate advanced non-volatile memories using DRAM and modified memory controllers that insert delays to model longer read and write latencies. Embodiments of the disclosure can model phase change memory (PCM) and can use the latencies from 48 ns and 150 ns for array reads and writes, respectively.

Unlike flash, phase change memory (PCM), as well as other NVMs typically does not require a separate erase operation to clear data before a write. This makes in-place updates possible and, therefore, eliminates the complicated flash translation layer that manages a map between logical storage addresses and physical flash storage locations to provide the illusion of in-place updates. PCM still requires wear-leveling and error correction, but fast hardware solutions exist for both of these in NVMs. Moneta can use start-gap wear leveling. With fast, in-place updates, Moneta may be able to provide low-latency, high-bandwidth access to storage that is limited only by the interconnect (e.g. PCIe) between the host and the device.

The design of ARIES and other data management systems (e.g., journaling file systems) typically relies critically on the atomicity, durability, and performance properties of the underlying storage hardware. Data management systems can combine these properties with locking protocols, rules governing how updates proceed, and other invariants to provide application-level atomicity and durability guarantees. As a result, the semantics and performance characteristics of the storage hardware may play a key role in determining the implementation complexity and overall performance of the complete system.

Embodiments of the disclosure can include a novel multi-part atomic write primitive, called editable redo logging (ERL) atomic writes, that supports complex logging protocols like ARIES-style write-ahead logging. In particular, ERL atomic writes can make it easy to support transaction isolation in a scalable way while aggressively leveraging the performance of next-generation, non-volatile memories. This feature is typically missing from existing atomic write interfaces designed to accelerate simpler transaction models (e.g., file metadata updates in journaling file systems) on flash-based SSDs.

ERL atomic writes can use write-ahead redo logs to combine multiple writes to arbitrary storage locations into a single atomic operation. ERL atomic writes can make it easy for applications to provide isolation between transactions by keeping the updates in a log until the atomic operation commits and exposing that log to the application. The application can freely update the log data (but not the log metadata) prior to commit. ERL atomic writes can be simple to use and strike a balance between implementation complexity and functionality while allowing an SSD to leverage the performance of fast NVMs. ERL atomic writes can require the application to allocate space for the log (e.g., by creating a log file) and to specify where the redo log entry for each write will reside. This can be used to avoid the need to statically allocate space for log storage and ensure that the application knows where the log entry resides so it can modify it as needed.

Below, the disclosure describes how an application can initiate an ERL atomic write, commit it, and manage log storage in the device. The disclosure also outlines how ERL atomic writes help simplify and accelerate ARIES-style transactions. The disclosure explains that hardware used to implement ERL atomic writes can be modest and that it can deliver large performance gains.

Applications can execute ERL atomic writes using the commands in Table 1 below. Each application accessing the storage device can have a private set of 64 transaction IDs (TIDs), and the application can be responsible for tracking which TIDs are in use. TIDs can be in one of three states: FREE (the TID is not in use), PENDING (the transaction is underway), or COMMITTED (the transaction has committed). TIDs can move from COMMITTED to FREE when the storage system notifies the host that the transaction is complete.

TABLE 1
Transaction commands - These commands, when used in
combination, can provide a way to execute atomic and durable
transactions and recover from failures.

| Command | Description |
|---|---|
| LogWrite (TID, file, offset, | Record a write to the log at the specified |
| data, len, logfile, logoffset) | offset. |
| Commit(TID) | Commit a transaction. |
| Abort(TID) | Cancel the transaction entirely, or perform a |
| Abort(TID, logfile, | partial rollback from a specified point in the |
| logoffset) | log. |
| AtomicWrite(TID, file, | Create and commit a transaction containing a |
| offset, data, len, logfile, | single write. |
| logoffset) | |

To create a new transaction with TID T, the application can pass T to LogWrite along with information that specifies the data to write, the ultimate target location for the write (i.e., a file descriptor and offset), and the location for the log data (i.e., a log file descriptor and offset). This operation can copy the write data to the log file but does not have to modify the target file. After the first LogWrite, the state of the transaction can change from FREE to PENDING. Additional calls to LogWrite can add new writes to the transaction.

The writes in a transaction can be made invisible to other transactions until after commit. However, the transaction generally can see its own writes prior to commit by keeping track of the log offsets that it associated with each LogWrite. The application can commit the transaction with Commit (T). In response, the storage array can assign the transaction a commit sequence number that can determine the commit order of this transaction relative to others. It then atomically can apply the LogWrites by copying the data from the log to their target locations.

When the Commit command completes, the transaction has logically committed, and the transaction can move to the COMMITTED state. If a system failure should occur after a transaction logically commits but before the system finishes writing the data back, then the SSD can replay the log during recovery to roll the changes forward. When log application completes, the TID can return to FREE and the hardware can notify the application that the transaction finished successfully. At this point, it is safe to read the updated data from its target locations and reuse the TID.

Three other commands can be used to round out an exemplary ERL atomic write interface: The Abort command aborts a transaction, releasing all resources associated with it. PartialAbort truncates the log at a specified location to support partial rollback. The AtomicWrite command creates and commits a single atomic write operation, saving one IO operation for singleton transactions.

An exemplary system according to the disclosure can store the log in a pair of ordinary files in the storage array: a logfile and a logmetadata file. The logfile can be designated for holding the data for the log. The application can create the logfile just like any other file and can be responsible for allocating parts of it to LogWrite operations. The application can be configured to modify its contents at any time.

The logmetadata file can contain information about the target location and log data location for each LogWrite. The contents of an exemplary logmetadata file can be privileged, since it contains raw storage addresses rather than file descriptors and offsets. Raw addresses can be necessary during crash recovery when file descriptors are meaningless and the file system may be unavailable (e.g., if the file system itself uses the ERL atomic write interface). A system daemon, called the metadata handler, can be configured to “install” logmetadata files on behalf of applications and mark them as unreadable and immutable from software.

Conventional storage systems usually allocate space for logs as well, but they often use separate disks to improve performance. An exemplary system according to the present disclosure can rely on the log being internal to the storage device, since performance gains can stem from utilizing the internal bandwidth of the storage array's independent memory banks. One possible embodiment can focus on the ARIES approach to write-ahead logging and recovery because it can influence the design of many commercial databases as a key building block in providing fast, flexible, and efficient ACID transactions.

The ARIES algorithm works as follows. Before modifying an object (e.g., a row of a table) in storage, ARIES first records the changes in a log and writes the log out to storage. To make recovery robust and to allow disk-based optimizations, ARIES records both the old version (undo) and new version (redo) of the data. On restart after a crash, ARIES brings the system back to the exact state it was in before the crash by applying the redo log. Then, ARIES reverts the effects of any transactions active at the time of the crash by applying the undo log.

ARIES has two primary goals: First, it aims to provide a rich interface for executing scalable, ACID transactions. Second, it aims to maximize performance on disk-based storage systems. ARIES achieves the first goal by providing several important features to higher-level software (e.g., the rest of the database) that support flexible and scalable transactions. For example, ARIES offers flexible storage management since it supports objects of varying length. It also allows transactions to scale with the amount of free storage space on disk rather than with the amount of available main memory. ARIES provides features such as operation logging and fine-grained locking to improve concurrency. These features are independent of the underlying storage system.

To achieve high performance on disk-based systems, ARIES also incorporates a set of design decisions that exploit the properties of disk: ARIES optimizes for long, sequential accesses and avoids short, random accesses whenever possible. These design decisions are usually a poor fit for advanced, solid-state storage arrays which provide fast random access, provide ample internal bandwidth, and can exploit many parallel operations. Below, the disclosure describes certain design decisions ARIES makes that optimize for disk and how they limit the performance of ARIES on an NVM-based storage device.

In ARIES, the system writes log entries to the log (a sequential write) before it updates the object itself (a random write). To keep random writes off the critical path, ARIES uses a no-force policy that writes updated pages back to disk lazily after commit. In fast NVM-based storage, random writes are no more expensive than sequential writes, so the value of no-force is much lower.

ARIES uses a steal policy to allow the buffer manager to “page out” uncommitted, dirty pages to disk during transaction execution. This lets the buffer manager support transactions larger than the buffer pool, group writes together to take advantage of sequential disk bandwidth, and avoid data races on pages shared by overlapping transactions. However, stealing requires undo logging so the system can roll back the uncommitted changes if the transaction aborts.

As a result, ARIES writes both an undo log and a redo log to disk in addition to eventually writing back the data in place. This means that, roughly speaking, writing one logical byte to the database requires writing three bytes to storage. For disks, this is a reasonable tradeoff because it avoids placing random disk accesses on the critical path and gives the buffer manager enormous flexibility in scheduling the random disk accesses that must occur. For fast NVMs, however, random and sequential access performance are nearly identical, so this trade-off can be re-examined.

ARIES uses disk pages as the basic unit of data management and recovery and uses the atomicity of page writes as a foundation for larger atomic writes. This reflects the inherently block-oriented interface that disks provide. ARIES also embeds a log sequence number (LSN) in each page to determine which updates to reapply during recovery.

As recent work highlights, pages and LSNs complicate several aspects of database design. Pages make it difficult to manage objects that span multiple pages or are smaller than a single page. Generating globally unique LSNs limit concurrency and embedding LSNs in pages complicates reading and writing objects that span multiple pages. LSNs also effectively prohibit simultaneously writing multiple log entries.

Advanced NVM-based storage arrays that implement ERL atomic writes can avoid these problems. Fast NVMs are byte-addressable rather than block addressable and ERL atomic writes can provide a much more flexible notion of atomicity, eliminating the hardware-based motivation for page-based management. Also, ERL atomic writes can serialize atomic writes inside the SSD and implement recovery in the storage array itself, eliminating the need for application-visible LSNs.

MARS is an alternative to ARIES that implements similar features as ARIES but reconsiders the design decisions described previously in the context of fast NVMs and ERL atomic write operations. MARS differs from ARIES in at least two ways. First, MARS can rely on the SSD (via ERL atomic write operations) to apply the redo log at commit time. Second, MARS can eliminate the undo log that ARIES uses to implement its page stealing mechanism.

MARS can be configured to use LogWrite operations for transactional updates to objects (e.g., rows of a table) in the database. This provides several advantages. Since LogWrite does not update the data in-place, the changes are not visible to other transactions until commit. This makes it easy for the database to implement isolation. MARS can also use Commit to efficiently apply the log.

This change means that MARS “forces” updates to storage on commit (as opposed to ARIES' no-force policy). The advantage of this approach is that Commit executes within the SSD, so it can utilize the full internal memory bandwidth of the SSD (32 GB/s in the exemplary embodiment described above) to apply the commits. This may outweigh any potential performance penalty due to making transaction commit synchronous. It also means that committing a transaction typically does not consume any IO interconnect bandwidth and does not require CPU involvement.

MARS can still be configured to support page stealing, but instead of writing uncommitted data to disk at its target location and maintaining an undo log, MARS can be configured to write the uncommitted data directly to the redo log entry corresponding to the LogWrite for the target location. When the system issues a Commit for the transaction, the system can write the updated data into place. Finally, MARS can be configured to operate on arbitrary-sized objects directly rather than pages and can avoid the need for LSNs by relying on the commit ordering that ERL atomic writes provide.

Combining these optimizations can eliminate the disk-centric overheads that ARIES incurs and exploit the performance of fast NVMS. MARS can be configured to eliminate the data transfer overhead in ARIES: MARS can be configured to sends one byte over the storage interconnect for each logical byte the application writes to the database. MARS can also be configured to leverage the bandwidth of the NVMs inside the SSD to improve commit performance.

Atomicity and durability can be critical to storage system design, and system designers have explored many different approaches to providing these guarantees. These include approaches targeting disks, flash-based SSDs, and non-volatile main memories (i.e., NVMs attached directly to the processor) using software, specialized hardware, or a combination of the two. The subject disclosure describes existing systems in this area and highlights the differences between them and exemplary embodiments of the disclosure described herein.

Many disk-oriented systems provide atomicity and durability via software with minimal hardware support. Many systems use ARIES-style write-ahead logging to provide durability, atomicity, and to exploit the sequential performance that disks offer. ARIES-style logging is ubiquitous in storage and database systems today. Recent work on segment-based recovery revisits the design of write-ahead logging for ARIES with the goal of providing efficient support for application-level objects. By removing LSNs on pages, segment-based recovery enables DMA or zero-copy IO for large objects and request reordering for small objects. Exemplary embodiment of the disclosure take advantage of the same optimizations because the hardware manages logs without using LSNs and without modifying the format or layout of logged objects.

Traditional implementations of write-ahead logging are a performance bottleneck in databases running on parallel hardware. The so-called Aether approach implements a series of optimizations to lower the overheads arising from frequent log flushes, log-induced lock contention, extensive context switching, and contention for centralized, in-memory log buffers. Fast NVM-based storage only exacerbates these bottlenecks, but exemplary systems according to the subject disclosure can be configured to eliminate them almost entirely because embodiments described herein can offload logging to hardware, remove lock contention and the in memory log buffers. With fast storage and a customized driver, exemplary embodiments of systems according to the subject disclosure can minimize context switching and log flush delays.

Stasis uses write-ahead logging to support building persistent data structures. Stasis provides full ACID semantics and concurrency for building high-performance data structures such as hash tables and B-trees. It would be possible to port Stasis to use ERL atomic writes, but achieving good performance would require significant change to its internal organization.

ERL atomic writes provide atomicity and durability at the device level. The Logical Disk provides a similar interface and presents a logical block interface based on atomic recovery units (ARUs)—an abstraction for failure atomicity for multiple writes. Like exemplary embodiments of the subject disclosure, ARUs do not provide concurrency control. Unlike exemplary embodiments of the subject disclosure, ARUs do not provide durability, but do provide isolation.

File systems, including write anywhere file layout (WAFL) and ZFS, use shadow paging to perform atomic updates. Although fast NVMs do not have the restrictions of disk, the atomic write support in exemplary systems according to the subject disclosure could help make these techniques more efficient. Recent work on byte-addressable, persistent memory such as BPFS extends shadow paging to work in systems that support finer-grain atomic writes. This work targets non-volatile main memory, but this scheme could be adapted to use ERL atomic writes as described below.

Researchers have provided hardware-supported atomicity for disks. Mime is a high-performance storage architecture that uses shadow copies for this purpose. Mime offers sync and barrier operations to support ACID semantics in higher-level software. Like exemplary embodiments of the subject disclosure, Mime can be implemented in the storage controller, but its implementation can be more complex since it maintains a block map for copy-on-write updates and maintains additional metadata to keep track of the resulting versions.

Flash-based SSDs offer improved performance relative to disk, making latency overheads of software-based systems more noticeable. They also include complex controllers and firmware that use remapping tables to provide wear-leveling and to manage flash's idiosyncrasies. The controller can provide an opportunity to provide atomicity and durability guarantees, and several groups have done so.

Transactional Flash (TxFlash) can extend a flash-based SSD to implement atomic writes in the SSD controller. TxFlash leverages flash's fast random write performance and the copy-on-write architecture of the FTL to perform atomic updates to multiple, whole pages with minimal overhead using “cyclic commit.” In contrast, fast NVMs are byte-addressable and SSDs based on these technologies can efficiently support in-place updates. Consequently, our system logs and commits requests differently and the hardware can handle arbitrarily sized and aligned requests.

Recent work from Fusion IO proposes an atomic-write interface in a commercial flash-based SSD. The Fusion IO system uses a log-based mapping layer in the drive's flash translation layer (FTL), but it requires that all the writes in one transaction be contiguous in the log. This prevents them from supporting multiple, simultaneous transactions.

The fast NVMs described for use in exemplary embodiments of the subject disclosure are also candidates for non-volatile replacements for DRAM, potentially increasing storage performance dramatically. Using non-volatile main memory as storage can require atomicity guarantees as well.

Recoverable Virtual Memory (RVM) provides persistence and atomicity for regions of virtual memory. It buffers transaction pages in memory and flushes them to disk on commit. RVM only requires redo logging because uncommitted changes are typically not written early to disk, but RVM also implements an in-memory undo log so that it can quickly revert the contents of buffered pages without rereading them from disk when a transaction aborts. RioVista builds on RVM but uses battery-backed DRAM to make stores to memory persistent, eliminating the redo log entirely. Both RVM and Rio Vista are limited to transactions that can fit in main memory.

More recently, Mnemosyne and NV-heaps provide transactional support for building persistent data structures in byte-addressable, non-volatile memories. Both systems map NVMs attached to the memory bus into the application's address space, making it accessible by normal load and store instructions. Embodiments of the subject disclosure can provide atomic write hardware support to help implement a Mnemosyne or NV-Heaps-like interface on a PCIe-attached storage device.

To make logging transparent and flexible, embodiments of the disclosure can leverage the existing software stack. First, exemplary embodiments can extend the user-space driver to implement the ERLAW API. In addition, exemplary embodiments can utilize the file system to manage the logs, exposing them to the user and providing an interface that lets the user dictate the layout of the log in storage.

SSDs proposed according to embodiments of the subject disclosure can provide a highly-optimized (and unconventional) interface for accessing data. They can provides a user-space driver that allows the application to communicate directly with the array via a private set of control registers, a private DMA buffer, and a private set of 64 tags that identify in-flight operations. To enforce file protection, the user space driver can work with the kernel and the file system to download extent and permission data into the SSD, which then can check that each access is legal. As a result, accesses to file data do not involve the kernel at all in the common case. Modifications to file metadata still go through the kernel. The user space interface lets exemplary SSD embodiments perform IO operations very quickly: 4 kB reads and writes execute in˜7 μs. Exemplary systems according to the subject disclosure can use this user space interface to issue LogWrite, Commit, Abort, and AtomicWrite requests to the storage array.

Embodiments of the subject disclosure can store their logs in normal files in the file system. They can use two types of files to maintain a log: a logfile and a metadata file. The log file can contain redo data as part of a transaction from the application. The user can create a log file and can extend or truncate the file as needed, based on the application's log space requirements, using regular file IO. The metadata file can record information about each update including the target location for the redo data upon transaction commit. A trusted process called the metadata handler can create and manage a metadata file on the application's behalf.

Embodiments can protect the metadata file from modification by an application. If a user could manipulate the metadata, the log space could become corrupted and unrecoverable. Even worse, the user might direct the hardware to update arbitrary storage locations, circumventing the protection of the OS and file system. To take advantage of the parallelism and internal bandwidth of the SSD, the user space driver can ensure the data offset and log offset for LogWrite and AtomicWrite requests target the same memory controller in the storage array. Embodiments of the subject application can accomplish this by allocating space in extents aligned to and in multiples of the SSD's 64 kB stripe width. With XFS, embodiments can achieve this by setting the stripe unit parameter with mkfs.xfs.

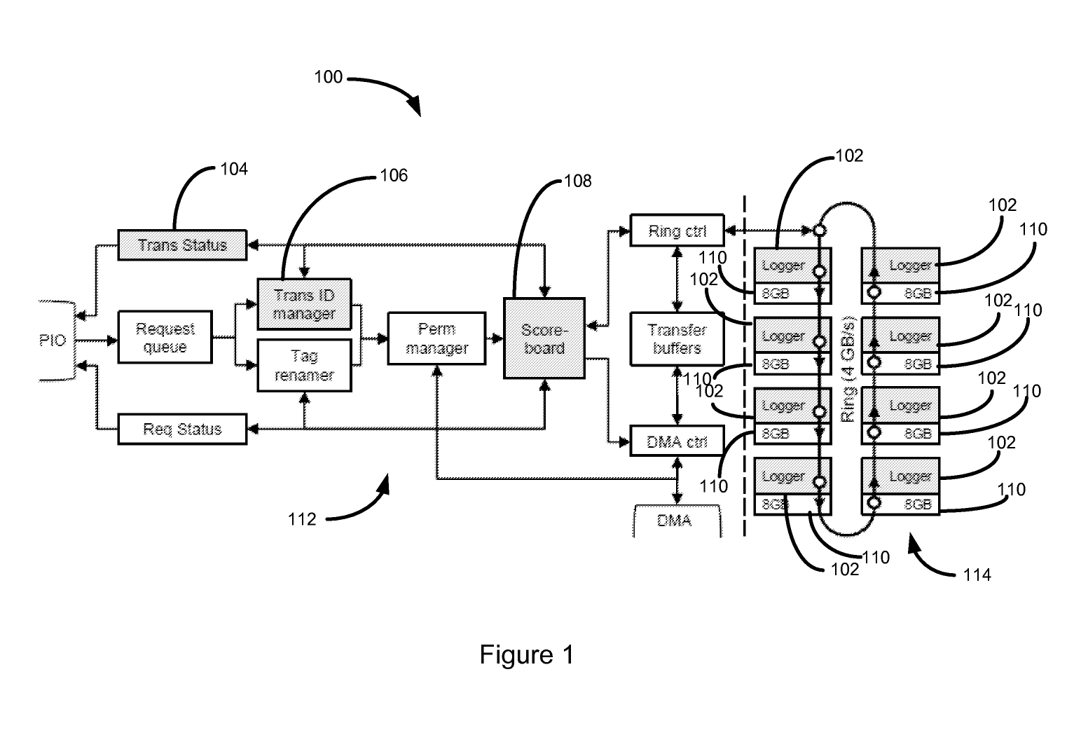

Referring now to FIG. 1, an implementation of an exemplary embodiment of the subject disclosure atomic write interface 100 can divide functionality between two types of hardware components. The first can be a logging module (see 300 in FIG. 3), called the logger 102, which resides at each of the system's eight memory controllers and handles logging for the local controller 114. The second can be a set of modifications to the central controller 104, 106 and 108 which orchestrate operations across the eight loggers. The layout of an exemplary log and components and protocols of one embodiment of the disclosure can use to coordinate logging, commit, and recovery is described in more detail below.

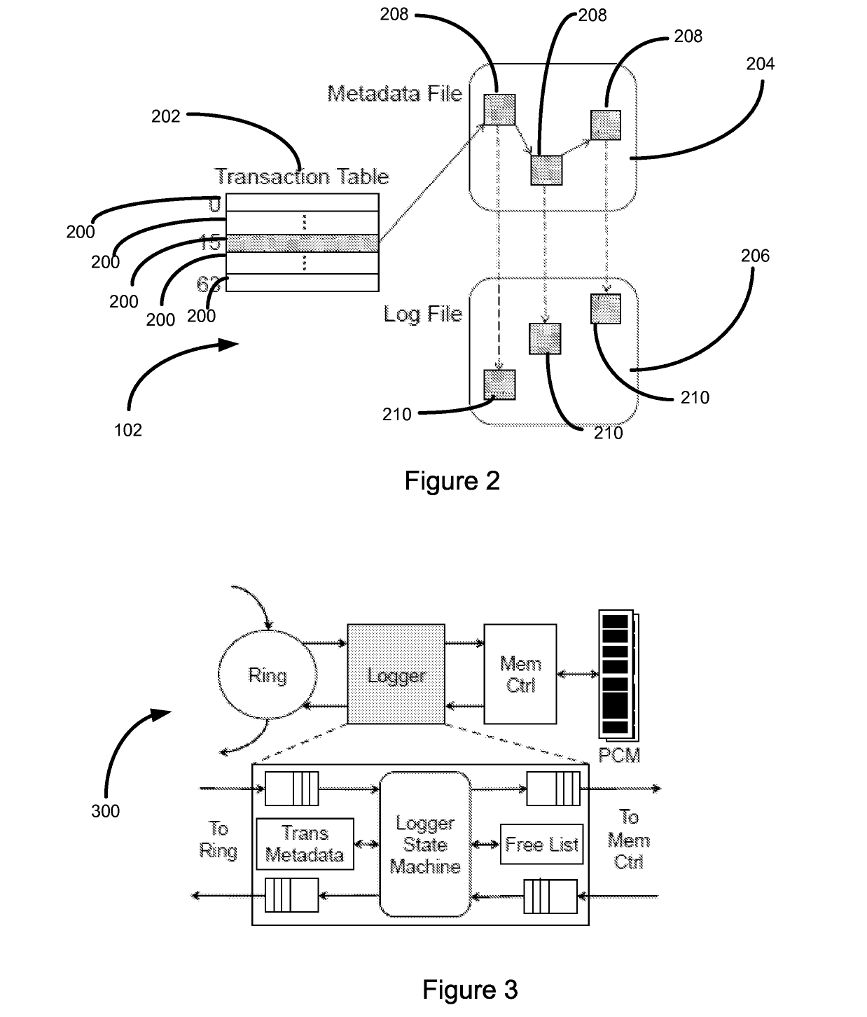

Each logger 102 can independently perform logging, commit, and recovery operations and handle accesses to NVM storage, such as 8 GB storage 110, at the memory controller. As shown in FIG. 2, each logger 102 can independently maintain a per-TID log as a collection of three types of entries: transaction table 202 entries, metadata 204 entries, and log file 206 entries. The system can reserve a small portion (2 kB) of the storage at each memory controller for a transaction table 202, which can store the state for 64 TIDs. Each transaction table entry 200 can include the status of the transaction, a sequence number, and the address of the head metadata entry in the log.

When the metadata handler installs a metadata file 204, the hardware can divide it into fixed-size metadata entries 208. Each metadata entry 208 can contain information about a log file 206 entry and the address of the next metadata entry for the same transaction. Each log file entry 212 can contain the redo data that the logger 102 will write back when the transaction commits.

The log for a particular TI Data logger can be simply a linked list. Each logger 102 can maintain a log for up to 64 TIDs. The log can be a linked list of metadata entries 208 with a transaction table entry 200 pointing to the head of the list. The transaction table entry 200 can maintain the state of the transaction and the metadata entries 208 can contain information about each LogWrite request. Each link in the list can describe the actions for a LogWrite that will occur at commit of metadata entries 208 with the transaction table entry 200 pointing to the head of the list. The complete log for a given TID (across the entire storage device) can simply be the union of each logger's log for that TID.

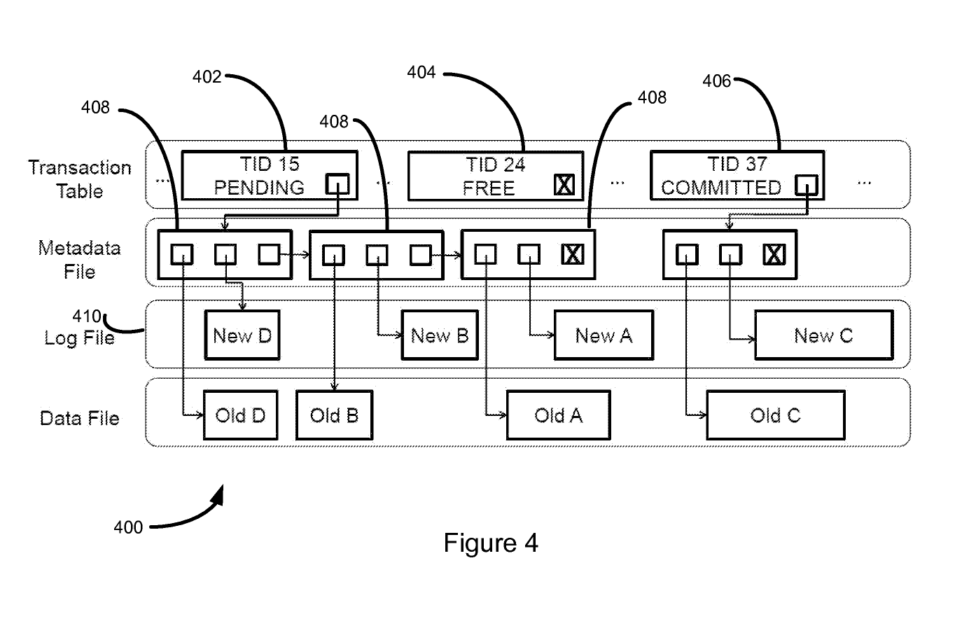

FIG. 4 illustrates one the state for three TIDs 402, 404, and 406 at one logger 400. In this example, the application has performed three LogWrite requests for TID 15 402. For each request, the logger 400 allocates a metadata entry 408, copies the data to a location in the log file 410, records the request information in the metadata entry 408, and then appends the metadata entry 408 to the log. The TID remains in a PENDING state until the application issues a Commit or Abort request. The application sends an Abort request for TID 24 402. The logger 400 deallocates all assigned metadata entries and clears the transaction status returning it to the FREE state.

When the application issues a Commit request for TID 37 406, the logger 400 waits for all outstanding writes to the log file 410 to complete and then marks the transaction as COMMITTED. At commit, the central controller (see below) can direct each logger 400 to apply their respective log. To apply the log, the logger 400 can read each metadata entry 408 in the log linked list, copy the redo data from the log file entry 410 to its destination address. During log application, the logger 400 can suspend other read and write operations to make log application atomic. At the end of log application, the logger 400 can deallocate the transaction's metadata entries 408 and return the TID to the FREE state.

A single transaction may require the coordinate efforts of one or more loggers 102. The central controller, 112 of FIG. 1 for example, can coordinate the concurrent execution of LogWrite, AtomicWrite, Commit, Abort, and log recovery commands across the loggers 102. Three hardware components can work together to implement transactional operations. First, the TID manager 106 can map virtual TIDs from application requests to physical TIDs and track the transaction commit sequence number for the system. Second, the transaction scoreboard 108 can track the state of each transaction and enforces ordering constraints during commit and recovery. Finally, the transaction status table 104 can export a set of memory-mapped IO registers that the host system interrogates during interrupt handling to identify completed transactions.

To perform a LogWrite, the central controller 112 can break up requests along stripe boundaries, send local LogWrites to affected memory controllers, and awaits their completion. To maximize performance, our system 100 can allow multiple LogWrites from the same transaction to be in-flight at once. If the LogWrites are to disjoint areas, they can behave as expected. The application is responsible for ensuring that LogWrites do not conflict.

On Commit, the central controller 112 can increment the global transaction sequence number and broadcast a commit command with the sequence number to the memory controller 114 that receive LogWrites. The loggers 102 can respond as soon as they have completed any outstanding LogWrite operations and have marked the transaction COMMITTED. When the central controller 112 receives all responses, it can signal the loggers 102 to begin applying the log and simultaneously notify the application that the transaction has committed. Notifying the application before the loggers 102 have finished applying the logs hides part of the log application latency. This is safe since only a memory failure (e.g., a failing NVM memory chip) can prevent log application from eventually completing. In that case, it is assumed that the entire storage device has failed and the data it contains is lost.

Adding support for atomic writes to a baseline system requires only a modest increase in complexity and hardware resources. An exemplary Verilog implementation of the logger 102 requires only minimal software coding. Changes to the central controller 112 are also small relative to existing central controller code bases.

Exemplary embodiments of the disclosure can coordinate recovery operations in the kernel driver rather than in hardware to minimize complexity. There are two problems that need to be overcome: The first is that some memory controllers may have marked a transaction as COMMITTED while others have not. In this case, the transaction must abort. Second, the system must apply the transactions in the correct order (as given by their commit sequence numbers).

On boot, an exemplary driver can scan the transaction tables 202 at each memory controller 114 to assemble a complete picture of transaction state across all the controllers. It can identify the TIDs and sequence numbers for the transactions that all loggers 102 have marked as COMMITTED and can sort them by sequence number. The kernel can then issue a kernel-only WriteBack command for each of these TIDs that triggers log replay at each logger. Finally, it can issue Abort commands for all the other TIDs. Once this is complete, the array is in a consistent state, and the driver can make the array available for normal use.

To verify the atomicity and durability of an exemplary ERL atomic write implementation, hardware support can be added to emulate system failure and perform failure and recovery testing. This presents a challenge since some exemplary DRAMs are volatile. To overcome this problem, support can be added to force a reset of the system, which immediately suspends system activity. During system reset, the memory controllers 114 can be kept active to send refresh commands to the DRAM in order to emulate non-volatility. The system can include capacitors to complete memory operations that the memory chips are in the midst of performing, just as many commercial SSDs do. To test recovery, a reset can be sent from the host while running a test, rebooting the host system, and running an exemplary recovery protocol. Then, an application-specific consistency check can be run to verify that no partial writes are visible.

Two workloads can be used for testing. The first workload consists of 16 threads each repeatedly performing an AtomicWrite to its own 8 kB region. Each write can consist of a repeated sequence number that increments with each write. To check consistency, the application can read each of the 16 regions and verify that they contain only a single sequence number and that that sequence number equals the last committed value. In the second workload, 16 threads can continuously insert and delete nodes from an exemplary B+tree. After reset, reboot, and recovery, the application can run a consistency check of the B+tree. The workloads can be run over a period of a few days, interrupting them periodically.

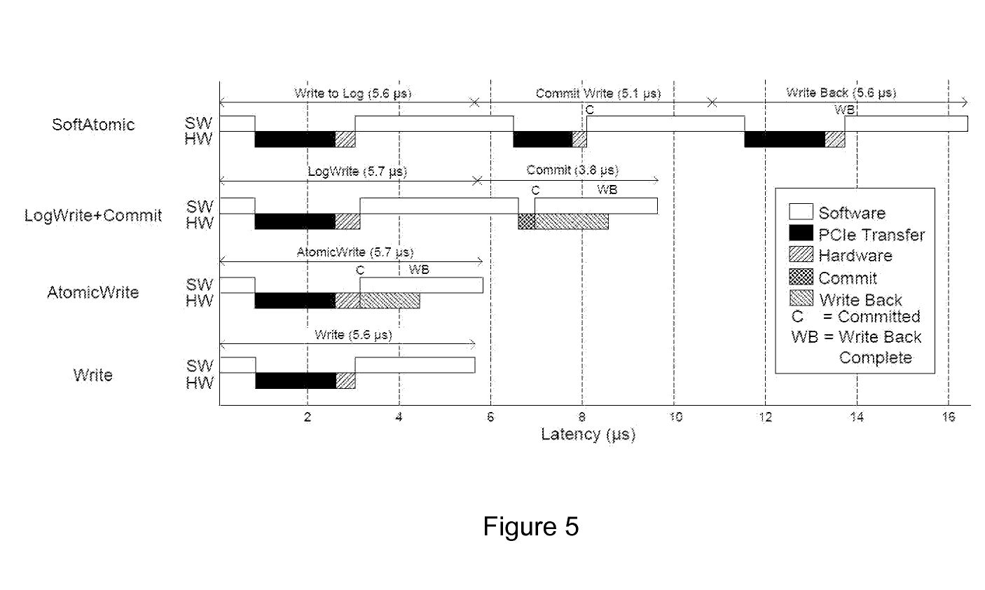

ERL atomic writes can eliminate the overhead of multiple writes that systems traditionally use to provide atomic, consistent updates to storage. FIG. 5 illustrates an exemplary overhead for each stage of a 512 B atomic write. This figure shows the overheads for a traditional implementation that uses multiple synchronous non-atomic writes (“SoftAtomic”), an implementation that uses LogWrite followed by a Commit (“LogWrite+Commit”), and one that uses AtomicWrite. As a reference, the latency breakdown for a single non-atomic write is included as well. For SoftAtomic the buffer writes in memory, flushes the writes to a log, writes a commit record, and then writes the data in place. A modified version of XDD is used to collect the data.

FIG. 5 shows transitions between hardware and software and two different latencies for each operation. The first is the commit latency between command initiation and when the application learns that the transaction logically commits (marked with “C”). For applications, this can be the critical latency since it corresponds to the write logically completing. The second latency, the write back latency, is from command initiation to the completion of the write back (marked with “WB”). At this point, the system has finished updating data in place and the TID becomes available for use again.

The largest source of latency reduction shown in FIG. 5 (accounting for 41.4%) comes from reducing the number of DMA transfers from three for SoftAtomic to one for the others (LogWrite+Commit takes two IO operations, but the Commit does not need a DMA). Using AtomicWrite to eliminate the separate Commit operation reduces latency by an additional 41.8%.

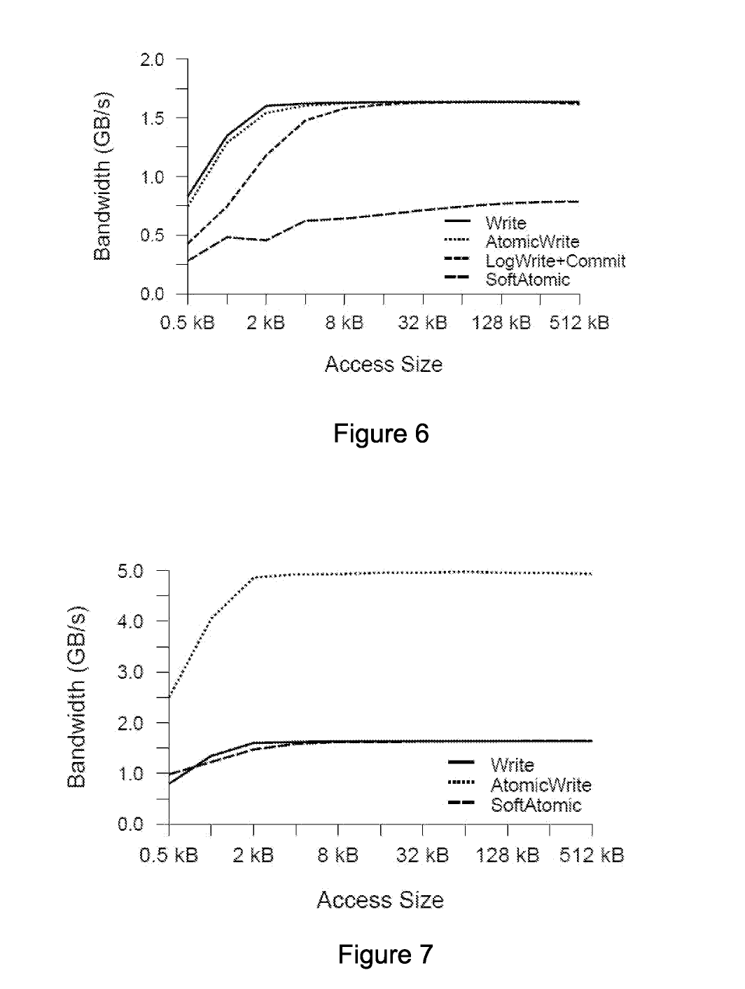

FIG. 6 plots the effective bandwidth (i.e., excluding writes to the log) for atomic writes ranging in size from 512 B to 512 kB. Exemplary schemes according to embodiment of the subject disclosure can increase throughput by between 2 and 3.8× or more relative to SoftAtomic. The data also show the benefits of AtomicWrite for small requests: transactions smaller than 4 kB achieve 92% of the bandwidth of normal writes in the baseline system.

FIG. 7 shows the source of the bandwidth performance improvement for ERL atomic writes. It plots the total bytes read or written across all the memory controllers internally. For normal writes, internal and external bandwidth are the same. SoftAtomic achieves the same internal bandwidth because it saturates the PCIe bus, but roughly half of that bandwidth goes to writing the log. LogWrite+Commit and AtomicWrite consume much more internal bandwidth (up to 5 GB/s), allowing them to saturate the PCIe link with useful data and to confine logging operations to the storage device where they can leverage the internal memory controller bandwidth.

MARS shows some very significant benefits when compared to ARIES. Using a benchmark that transactionally swaps objects (pages) in a large database-style table, a baseline implementation of ARIES performs the undo and redo logging required for steal and no-force. It includes a checkpoint thread that manages a pool of dirty pages, flushing pages to the storage array as the pool fills.

Exemplary implementations of MARS can use ERL atomic writes to eliminate the no-force and steal policies. Exemplary hardware can implement a force policy at the memory controllers and can rely on the log to hold the most recent copy of an object prior to commit, giving it the benefits of a steal policy without requiring undo logging. Using a force policy in hardware eliminates the extra IO requests needed to commit and write back data. Removing undo logging and write backs reduces the amount of data sent to the storage array over the PCIe link by a factor of three.

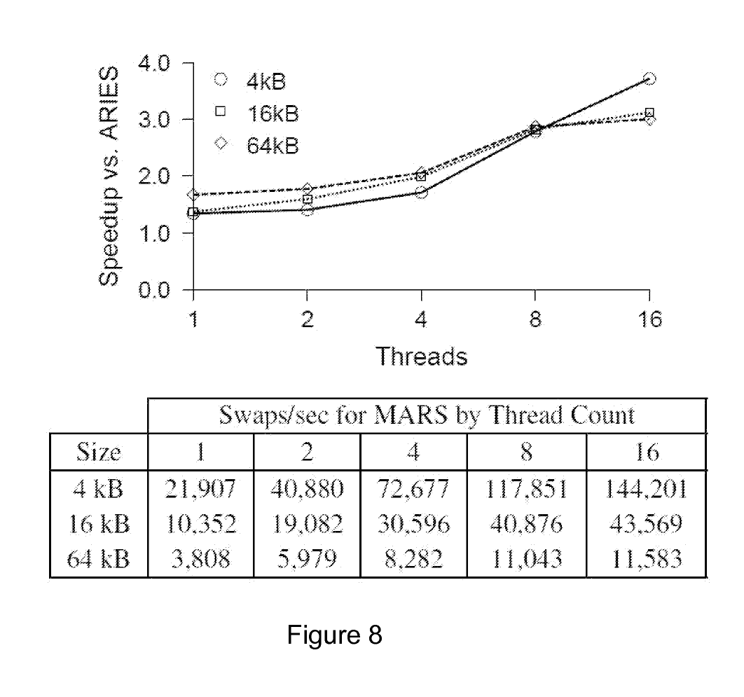

FIG. 8 shows the speed up of MARS compared to ARIES for between 1 and 16 threads concurrently swapping objects of between 4 and 64 kB. For small transactions, where logging overheads are largest, our system outperforms ARIES by as much as 3.7× or more. For larger objects, the gains are smaller—3.1× or more for 16 kB objects and 3× or more for 64 kB. In these cases, ARIES makes better use of the available PCIe bandwidth, compensating for some of the overhead due to additional logs writes and write backs. MARS scales better than ARIES: speedup monotonically increases with additional threads for all object sizes while the performance of ARIES declines for 8 or more threads.

The impact of ERL atomic writes on several light-weight persistent data structures designed to take advantage of our user space driver and transactional hardware support is also evaluated: a hash table, a B+tree, and a large scale-free graph that supports “six degrees of separation” queries.

The hash table implements a transactional key-value store. It resolves collisions using separate chaining, and it uses per-bucket locks to handle updates from concurrent threads. Typically, a transaction requires only a single write to a key-value pair. But, in some cases an update requires modifying multiple key-value pairs in a bucket's chain. The footprint of the hash table can be 32 GB, and exemplary embodiments can use 25 B keys and 1024 B values for example. Each thread in the workload repeatedly picks a key at random within a specified range and either inserts or removes the key-value pair depending on whether or not the key is already present.

The B+tree also implements a 32 GB transactional key-value store. It caches the index, made up of 8 kB nodes in memory for quick retrieval. To support a high degree of concurrency, it can use a Bayer and Scholnick's algorithm based on node safety and lock coupling. The B+tree can be a good case study for ERL atomic writes because transactions can be complex: An insertion or deletion may cause splitting or merging of nodes throughout the height of the tree. Each thread in this workload repeatedly inserts or deletes a key-value pair at random.

Six Degrees operates on a large, scale-free graph representing a social network. It alternately searches for six-edge paths between two queried nodes and modifies the graph by inserting or removing an edge. Exemplary embodiments use a 32 GB footprint for the undirected graph and store it in adjacency list format. Rather than storing a linked list of edges for each node, examples can use a linked list of edge pages, where each page contains up to 256 edges. This allows us to read many edges in a single request to the storage array. Each transactional update to the graph acquires locks on a pair of nodes and modifies each node's linked list of edges.

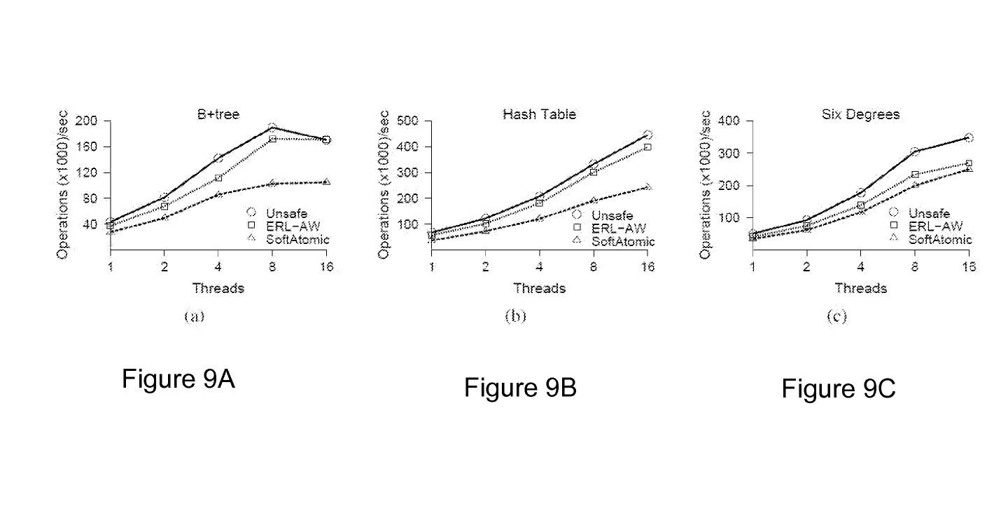

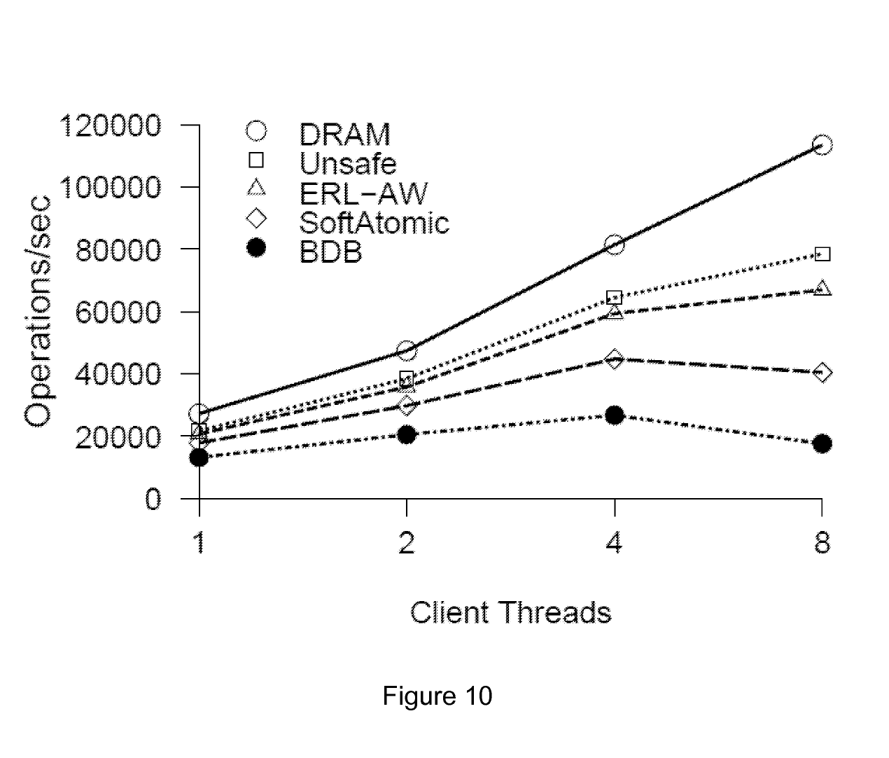

FIGS. 9a, b, and c show the performance for three implementations of each workload running with between 1 and 16 threads. The first implementation, “Unsafe,” does not provide any durability or atomicity guarantees and represents an upper limit on performance. For all three workloads, adding ACID guarantees in software reduces performance by between 28 and 46% compared to Unsafe. For the B+tree and hash table, ERL atomic writes sacrifice just 13% of the performance of the unsafe versions on average. Six Degrees, on the other hand, sees a 21% performance drop with ERL atomic writes because its transactions are longer and modify multiple nodes. Using ERL atomic writes also improves scaling slightly. For instance, the ERL atomic write version of Hash Table closely tracks the performance improvements of the Unsafe version, with only an 11% slowdown at 16 threads while the SoftAtomic version is 46% slower.

To understand the impact of ERL atomic writes at the application level, a hash table can be integrated into MemcacheDB, a persistent version of Memached, and the popular key-value store. The original Memcached can use a large hash table to store a read-only cache of objects in memory. MemcacheDB can support safe updates by using Berkeley DB to make the key-value store persistent. MemcacheDB can use a client-server architecture, and it can run on a single computer acting as both clients and server.

FIG. 9 compares the performance of MemcacheDB using an exemplary ERL atomic write-based hash table as the key-value store to versions that use volatile DRAM, a Berkeley DB database (labeled “BDB”), an in-storage key-value store without atomicity guarantees (“Unsafe”), and a SoftAtomic version. For eight threads, an exemplary system is 41% slower than DRAM and 15% slower than the Unsafe version. It is also 1.7× faster than the SoftAtomic implementation and 3.8× faster than BDB. Beyond eight threads, performance degrades because MemcacheDB uses a single lock for updates.

Existing transaction mechanisms such as ARIES were designed to exploit the characteristics of disk, making them a poor fit for storage arrays of fast, non-volatile memories. Embodiments of the subject disclosure presented a redesign of ARIES, called MARS, that provides a similar set of features to the application but that utilizes a novel multi-part atomic write operation, called editable redo logging (ERL) atomic writes, that takes advantage of the parallelism and performance in fast NVM-based storage. These exemplary embodiments demonstrate MARS and ERL atomic writes in an exemplary storage array. Compared to transactions implemented in software, exemplary embodiments of the subject disclosure increase effective bandwidth by up to 3.8× or more and decreases latency by 2.9× or more. When applied to MARS, ERL atomic writes yield a 3.7× or more performance improvement relative to a baseline implementation of ARIES. Across a range of persistent data structures, ERL atomic writes improve operation throughput by an average of 1.4× or more.

Applications such as databases, file systems, and web services are ubiquitous and their performance demands continue to grow. Solid-state drives are a promising solution to meet these performance demands. SSDs are replacing hard drives in many demanding storage applications, and they are estimated to become a $10 Billion market. SSDs are compromised of storage technologies that provide low latency, high bandwidth, and high parallelism. Existing software support for transactions fails to take advantage of the performance potential of these technologies, but exemplary embodiments of the subject disclosure can exploit these technologies and effectively make transactions as fast as normal updates.

Our exemplary SSD with atomic write support embodiments reduce latency by 3 times or more and improve effective bandwidth by up to nearly 4 times or more when compared to a traditional, software logging protocol. This is a key performance improvement for applications that must guarantee the integrity of their data. Also, exemplary embodiments of the subject disclosure integrate with existing transaction mechanisms to provide the important high-level features needed in databases and other applications.

While various embodiments of the present invention have been described above with regard to particular contexts/implementations, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Furthermore, embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

### REFERENCES

1. D. G. Andersen, J. Franklin, M. Kaminsky, A. Phanishayee, L. Tan, and V. Vasudevan. FAWN: a fast array of wimpy nodes. In Proceedings of the ACM SIGOPS 22nd symposium on Operating systems principles, SOSP '09, pages 1-14, New York, N.Y., USA, 2009. ACM.
2. R. Bayer and M. Schkolnick. Concurrency of operations on B-trees. Acta Informatica, 9:1-21, 1977.
3. http://beecube.com/products/.
4. M. J. Breitwisch. Phase change memory. Intercon-nect Technology Conference, 2008. IITC 2008. In-ternational, pages 219-221, June 2008.
5. A. M. Caulfield, A. De, J. Coburn, T. I. Mollov, R. K. Gupta, and S. Swanson. Moneta: A high-performance storage array architecture for next-generation, non-volatile memories. In Proceedings of the 43nd Annual IEEE/ACM International Symposium on Microarchitecture, MICRO 43, pages 385-395, New York, N.Y., USA, 2010. ACM.
6. A. M. Caulfield, T. I. Molloy, L. Eisner, A. De, J. Coburn, and S. Swanson. Providing safe, user space access to fast, solid state disks. In Proceedings of the seventeenth international conference on Architectural support for programming languages and operating systems, ASPLOS '12. ACM, 2012.
7. C. Chao, R. English, D. Jacobson, A. Stepanov, and J. Wilkes. Mime: a high performance parallel storage device with strong recovery guarantees. Technical Report HPL-CSP-92-9R1, HP Laboratories, November 1992.
8. S. Chu. Memcachedb. http://memcachedb.org/.
9. J. Coburn, A. M. Caulfield, A. Akel, L. M. Grupp, R. K. Gupta, R. Jhala, and S. Swanson. NV-heaps: making persistent objects fast and safe with next-generation, non-volatile memories. In Proceedings of the sixteenth international conference on Architectural support for programming languages and operating systems, ASPLOS '11, pages 105-118, New York, N.Y., USA, 2011. ACM.
10. J. Condit, E. B. Nightingale, C. Frost, E. Ipek, B. Lee, D. Burger, and D. Coetzee. Better i/o through byte-addressable, persistent memory. In Proceedings of the ACM SIGOPS 22nd symposium on Operating systems principles, SOSP '09, pages 133-146, New York, N.Y., USA, 2009. ACM.
11. O. Corporation. ZFS. http://hub.opensolaris.org/bin/view/Community+Group+zfs/.
12. W. de Jonge, M. F. Kaashoek, and W. C. Hsieh. The logical disk: a new approach to improving file sys-tems. In Proceedings of the fourteenth ACM symposium on Operating systems principles, SOSP '93, pages 15-28, New York, N.Y., USA, 1993. ACM.
13. B. Debnath, S. Sengupta, and J. Li. ChunkStash: speeding up inline storage deduplication using flash memory. In Proceedings of the 2010 USENIX conference on USENIX annual technical conference, USENIXATC '10, pages 16-16, Berkeley, Calif., USA, 2010. USENIX Association.
14. B. Debnath, S. Sengupta, and J. Li. FlashStore: high throughput persistent key-value store. Proc. VLDB Endow., 3:1414-1425, September 2010.
15. B. Debnath, S. Sengupta, and J. Li. SkimpyStash: RAM space skimpy key-value store on flash-based storage. In Proceedings of the 2011 international conference on Management of data, SIGMOD '11, pages 25-36, New York, N.Y., USA, 2011. ACM.
16. B. Dieny, R. Sousa, G. Prenat, and U. Ebels. Spin-dependent phenomena and their implementation in spintronic devices. VLSI Technology, Systems and Applications, 2008. VLSI-TSA 2008. International Symposium on, pages 70-71, April 2008.
17. R. Grimm, W. Hsieh, M. Kaashoek, and W. de Jonge. Atomic recovery units: failure atomicity for logical disks. Distributed Computing Systems, International Conference on, 0:26-37, 1996.
18. D. Hitz, J. Lau, and M. A. Malcolm. File system design for an NFS file server appliance. In USENIX Winter, pages 235-246, 1994.
19. International technology roadmap for semiconductors: Emerging research devices, 2009.
20. R. Johnson, I. Pandis, R. Stoica, M. Athanassoulis, and A. Ailamaki. Aether: a scalable approach to logging. Proc. VLDB Endow., 3:681-692, September 201022.
21. B. C. Lee, E. Ipek, O. Mutlu, and D. Burger. Architecting phase change memory as a scalable dram alternative. In ISCA '09: Proceedings of the 36th annual international symposium on Computer ar-chitecture, pages 2-13, New York, N.Y., USA, 2009. ACM.
22. D. E. Lowell and P. M. Chen. Free transactions with rio vista. In SOSP '97: Proceedings of the sixteenth ACM symposium on Operating systems principles, pages 92-101, New York, N.Y., USA, 1997. ACM.
23. Memcached. http://memcached.org/.
24. C. Mohan, D. Haderle, B. Lindsay, H. Pirahesh, and P. Schwarz. Aries: a transaction recovery method supporting fine-granularity locking and partial roll-backs using write-ahead logging. ACM Trans. Database Syst., 17(1):94-162, 1992.
25. X. Ouyang, D. Nellans, R. Wipfel, D. Flynn, and D. Panda. Beyond block i/o: Rethinking traditional storage primitives. In High Performance Computer Architecture (HPCA), 2011 IEEE 17th International Symposium on, pages 301-311, February 2011.
26. V. Prabhakaran, T. L. Rodeheffer, and L. Zhou. Transactional flash. In Proceedings of the 8th USENIX conference on Operating systems design and implementation, OSDI'08, pages 147-160, Berkeley, Calif., USA, 2008. USENIX Association.
27. M. K. Qureshi, J. Karidis, M. Franceschini, V. Srini-vasan, L. Lastras, and B. Abali. Enhancing lifetime and security of pcm-based main memory with start-gap wear leveling. In MICRO 42: Proceedings of the 42nd Annual IEEE/ACM International Symposium on Microarchitecture, pages 14-23, New York, N.Y., USA, 2009. ACM.
28. M. K. Qureshi, A. Seznec, L. A. Lastras, and M. M. Franceschini. Practical and secure

PCM systems by online detection of malicious write streams. High-Performance Computer Architecture, International Symposium on, 0:478-489, 2011.
29. M. Satyanarayanan, H. H. Mashburn, P. Kumar, D. C. Steere, and J. J. Kistler. Lightweight recoverable virtual memory. In SOSP '93: Proceedings of the fourteenth ACM symposium on Operating systems principles, pages 146-160, New York, N.Y., USA, 1993. ACM.
30. S. Schechter, G. H. Loh, K. Straus, and D. Burger. Use ecp, not ecc, for hard failures in resistive memories. In Proceedings of the 37th annual international symposium on Computer architecture, ISCA '10, pages 141-152, New York, N.Y., USA, 2010. ACM.
31. R. Sears and E. Brewer. Stasis: flexible transactional storage. In OSDI '06: Proceedings of the 7th symposium on Operating systems design and implementation, pages 29-44, Berkeley, Calif., USA, 2006. USENIX Association.
32. R. Sears and E. Brewer. Segment-based recovery: write-ahead logging revisited. Proc. VLDB Endow., 2:490-501, August 2009
33. H. Volos, A. J. Tack, and M. M. Swift. Mnemosyne: Lightweight persistent memory. In ASPLOS '11: Proceeding of the 16th international conference on Architectural support for programming languages and operating systems, New York, N.Y., USA, 2011. ACM.
34. XDD version 6.5. http://www.ioperformance.com/.

What is claimed is:

1. A method for issuing transactions to a non-volatile memory unit storage array without interacting with an operating system, comprising:
providing a user-space driver configured to allow an application to communicate directly with the storage array via a private set of control registers, a private direct memory access buffer, and a private set of in-flight operations identifying tags; and
modifying the user-space driver to implement an interface, the interface allowing the application to dictate data layout in a log.

2. The method of claim 1, wherein data and log space are collocated at each memory controller of the non-volatile memory unit storage array.

3. The method of claim 1 further comprising, performing hardware permission checks on file access.

4. The method of claim 3, wherein the file access comprises at least one an application-issued LogWrite operation, a Commit operation, an Abort operation, and an AtomicWrite operation.

5. The method of claim further comprising, providing the application with the private set of in-flight operations identifying tags.

6. A multi-part atomic copy method comprising:
specifying a set of pairs of source and destination locations that define a set of copy instructions;
providing the set of pairs of source and destination locations to a solid state device;
executing the copy instructions by the solid state device atomically by copying contents from the pair of source locations to the pair of destination locations.

7. The method of claim 6, wherein executing the copy instructions by the solid state device atomically further comprises logically copying the contents from the pair of source locations to the pair of destination locations.

8. The method of claim 6, wherein executing the copy instructions by the solid state device atomically further comprises physically copying the contents from the pair of source locations to the pair of destination locations.

9. The method of claim 6, wherein providing the set of pairs of source and destination locations to a solid state device further comprises providing the set of pairs of source and destination locations each singly.

10. The method of claim 6, wherein providing the set of pairs of source and destination locations to a solid state device further comprises providing the set of pairs of source and destination locations each in a group.

11. The method of claim 6 wherein the solid state device block other operations affecting the contents from the pair of source locations to provide atomicity.

12. The method of claim 6, wherein the solid state device records a sequence of copies to be made so the sequence can be replayed on startup in the case of a system failure to further ensure atomicity.
